(19) United States
(12) Patent Application Publication
(10) Pub. No.: US 2025/0080290 A1
(43) Pub. Date: Mar. 6, 2025

(54) METHOD AND SYSTEM FOR CARRIER AGGREGATION DUPLICATION ENHANCEMENT

(71) Applicant: Samsung Electronics Co., Ltd., Suwon-si (KR)

(72) Inventors: Shweta M, Bangalore (IN); Gunjan Kumar SINGH, Bangalore (IN)

(21) Appl. No.: 18/815,278

(22) Filed: Aug. 26, 2024

Related U.S. Application Data
(63) Continuation of application No. PCT/KR2024/010897, filed on Jul. 26, 2024.

(30) Foreign Application Priority Data
Aug. 31, 2023 (IN) 202341058623

(51) Int. Cl. H04L 5/00; H04L 45/24

(52) U.S. Cl. CPC H04L 5/0032; H04L 5/0057; H04L 45/24

(57) ABSTRACT

A method for managing carrier aggregation (CA) duplication in a network entity is provided. The method includes configuring a plurality of carrier paths in at least one radio link control (RLC) entity of the network entity, configuring at least one path as a primary path and at least another path as a secondary path from among the plurality of configured carrier paths based on a path configuration criteria, selecting at least one of the primary path and the secondary path for transmission of data packets based on at least one of the path configuration criteria and a packet-specific criteria, and transmitting the data packets on the selected paths.

### CROSS-REFERENCE TO RELATED APPLICATION(S)

This application is a continuation application, claiming priority under § 365 (c), of an International application No. PCT/KR2024/010897, filed on Jul. 26, 2024, which is based on and claims the benefit of an Indian Patent Application number 202341058623, filed on Aug. 31, 2023, in the Indian Patent Office, the disclosure of which is incorporated by reference herein in its entirety.

### TECHNICAL FIELD

The disclosure relates to the field of wireless communication. More particularly, the disclosure relates to a method and a system for managing carrier aggregation (CA) duplication in a network device.

### BACKGROUND ART

5th generation (5G) technology introduces various enhanced features such as packet data convergence protocol (PDCP) duplication, carrier aggregation (CA), and split bearers in radio link control acknowledgment mode (RLC-AM) to improve the throughput and reliability of various network entities. Duplication is a technique that allows the transmission of the same data through multiple paths for redundancy. It can be implemented as CA duplication (Stand Alone) or dual connectivity (DC) duplication (Non-Stand Alone), or both, as defined by third generation partnership project (3GPP) technical standards (TS), for example, 3GPP TS 38.323. Activation of the duplication depends on various factors such as service type (e.g., ultra-reliable low latency communication (URLLC) or services with stringent requirements for latency and reliability as specified 3GPP TS 22.804, as shown in Table 1 below) or specific situations like cell edge where data from one cell may not reach to a user equipment (UE) properly.

TABLE 1

| Use cases | Latency | Reliability |
|---|---|---|
| Fire detection and triggering | 10 milliseconds | 99.9999% |
| of safety measures | (ms) | |
| Condition monitoring for | 5 ms to | 99.9999% to |
| safety in Massive wireless | 10 ms | 99.999999% |
| sensor networks | | |
| Power distribution grid fault | 5 ms | 99.9999% |
| and outage management | | |
| Supervisory control and | 4 ms | 99.999999999% |
| data acquisition (SCADA) | | |
| grid protection traffic | | |
| Low-Latency audio streaming | 4 ms | 99.9999% |
| for local conference systems | | |
| High data rate video | 10 ms | 99.9999% |
| streaming/professional | | |
| video production | | |

Table 1 provides examples of use cases that may not strictly fall under URLLC key performance indexes (KPIs) but have strict requirements for latency and reliability, thus requiring duplication. Further, Table 1 indicates the end-to-end latency required by the services. The end-to-end latency is not completely allocated to the 5G technology in case other networks are in a communication path.

FIG. 1 illustrates an existing CA duplication architecture, according to the related art.

This PDCP duplication feature can be enabled in combinations like dual connectivity (DC), CA, or CA and DC. For example, referring to FIG. 1, in the case of the CA, a PDCP entity 10 is associated with multiple RLC entities 20 and 30, transmitting duplicated PDCP protocol data units (PDUs) to the multiple RLC entities 20 and 30. Upon receiving acknowledgment from any one of the RLC entities (i.e., primary RLC entity 20 and secondary RLC entity 30), the PDCP entity 10 instructs the others (other RLC entity) to discard the packets. Additionally, the PDCP duplication over an uplink (UL)/a downlink (DL) may utilize split bearers or multiple carriers to transmit identical packets over both bearers, thereby ensuring high reliability and reduced latency.

However, the PDCP duplication feature or said existing CA architecture also has a few problems. The existing CA architecture is described in standards (i.e., 3GPP TS 38.323 and 3GPP TS 38.300 (16.1.3)). One problem identified herein is a requirement for at least two RLC entities (i.e., 20 and 30), as illustrated in FIG. 1. The existing CA architecture necessitates the involvement of two RLC entities. The number of RLC entities that can be supported by a distributed unit (DU) is limited by design constraints and resource considerations (resources such as timers and memory required for each RLC entity (e.g., 20 and 30). This limitation can significantly reduce the number of unique user equipment (UE) that can be supported by the DU when a significant portion of UEs requires duplication support.

Another problem identified herein is a high utilization of radio resources in the existing CA architecture for certain scenarios, as described in conjunction with FIG. 2.

FIG. 2 is a flow diagram illustrating a CA duplication method associated with the existing CA architecture, according to the related art.

In the existing CA architecture, every packet transmitted on two independent carriers/paths consumes double the required radio resources. This increased resource utilization may lead to inefficient allocation and management of radio resources.

Additionally, another problem identified herein is an inefficient discard process in the existing CA architecture, which involves multiple steps including notification from one RLC entity to the PDCP entity 10, as described in conjunction with FIG. 3.

FIG. 3 is a flow diagram illustrating a PDCP-RLC discard mechanism associated with the existing CA architecture, according to the related art.

In the inefficient discard process, the discard of duplicated packets involves multiple steps, including a notification from one RLC entity (i.e., 20 and 30) to the PDCP entity 10 indicating successful transmission/delivery. Subsequently, the PDCP entity 10 sends a discard notification to the other RLC entity or entities if more than two RLC entities (e.g., 20 and 30) are involved. In scenarios where a centralized unit (CU) and DU are not physically co-located, the transfer of acknowledgment (ACK) and discard indication adds latency to the discard process. Furthermore, if an RLC sequence number (SN) has been assigned to the packet and state variables are updated, the packet cannot be successfully discarded and at least one transmission of the packet or further retransmissions of the packet (until ACK is received) may happen on the other RLC entity (e.g., 20).

Thus, it is desired to address the above-mentioned problems or disadvantages or other shortcomings or at least provide a useful alternative for managing the CA duplication.

The above information is presented as background information only to assist with an understanding of the disclosure. No determination has been made, and no assertion is made, as to whether any of the above might be applicable as prior art with regard to the disclosure.

### DISCLOSURE OF INVENTION

### Solution to Problem

Aspects of the disclosure are to address at least the above-mentioned problems and/or disadvantages and to provide at least the advantages described below. Accordingly, an aspect of the disclosure is to provide a method and a system for managing carrier aggregation (CA) duplication in a network device.

Additional aspects will be set forth in part in the description which follows and, in part, will be apparent from the description, or may be learned by practice of the presented embodiments.

In accordance with an aspect of the disclosure, a method for managing carrier aggregation (CA) duplication in a network entity is provided. The method includes configuring a plurality of carrier paths in at least one radio link control (RLC) entity of the network entity, configuring at least one path as a primary path and at least another path as a secondary path from among the plurality of configured carrier paths based on a path configuration criteria, selecting at least one of the primary path and the secondary path for transmission of data packets based on at least one of the path configuration criteria and a packet-specific criteria, and transmitting the data packets on the selected paths.

In accordance with another aspect of the disclosure, a network entity for managing the CA duplication is provided. The network entity includes memory storing one or more computer programs, communication circuitry, and one or more processors coupled to the memory and the communication circuitry, wherein the one or more computer programs include computer-executable instructions that, when executed by the one or more processors, cause the network entity to configure the plurality of carrier paths in the at least one RLC entity of the network entity, configure at least one path as the primary path and at least another path as the secondary path from among the plurality of configured carrier paths based on the path configuration criteria, select at least one of the primary path and the secondary path for transmission of data packets based on at least one of the path configuration criteria and the packet-specific criteria, and transmit the data packets on the selected paths.

In accordance with another aspect of the disclosure, one or more non-transitory computer-readable storage media storing one or more computer programs including computer-executable instructions that, when executed by one or more processors of a network entity, cause the network entity to perform operations are provided. The operations include configuring a plurality of carrier paths in at least one radio link control (RLC) entity of the network entity, configuring at least one path as a primary path and at least another path as a secondary path from among the plurality of configured carrier paths based on a path configuration criteria, selecting at least one of the primary path and the secondary path for transmission of data packets based on at least one of the path configuration criteria and a packet-specific criteria, and transmitting the data packets on the selected paths.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an existing CA duplication architecture, according to the related art;

FIG. 2 is a flow diagram illustrating a CA duplication method associated with the existing CA architecture, according to the related art;

FIG. 3 is a flow diagram illustrating a PDCP-RLC discard mechanism associated with the existing CA architecture, according to the related art;

FIG. 4 illustrates a disclosed CA duplication architecture, according to an embodiment of the disclosure;

FIG. 5 is a flow diagram illustrating a method for transmitting a packet with a single RLC entity based on a path configuration and a path selection, according to an embodiment of the disclosure;

FIG. 6 is a flow diagram illustrating a method for transmitting the packet with the single RLC entity based on the path configuration and the path selection by utilizing a timer, according to an embodiment of the disclosure;

FIG. 7 illustrates a disclosed CA-DC duplication architecture, according to an embodiment of the disclosure;

FIG. 8 illustrates a block diagram of an RLC entity for managing CA duplication in a network device, according to an embodiment of the disclosure; and

FIG. 9 is a flow diagram illustrating a method for managing the CA duplication in the network device, according to an embodiment of the disclosure.

Throughout the drawings, like reference numerals will be understood to refer to like parts, components, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, micro controllers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

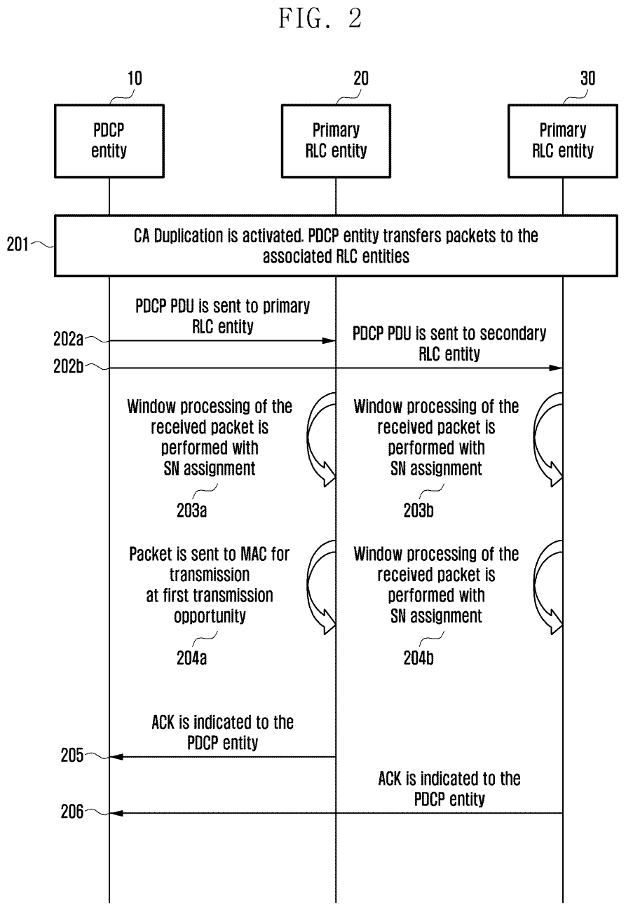

FIG. 2 is a flow diagram illustrating a CA duplication method associated with the existing CA architecture, according to the related art.

In operation 201, the PDCP entity 10 transfers packets to the associated RLC entities, namely the primary RLC entity 20 and secondary RLC entity 30, upon detecting activation of a Carrier Aggregation (CA) duplication in a network. The network is a system of interconnected communication devices and infrastructure that allows users to communicate with one another. This includes both wired and wireless networks, for example, cellular networks or the like. In operation 202a, when the CA duplication is detected, the PDCP entity 10 transfers the packets to the primary RLC entity 20. Similarly, in operation 202b, when CA duplication is detected, the PDCP entity 10 transfers the packets to the secondary RLC entity 30. Upon receiving the packets from the PDCP entity 10, the primary RLC entity 20 performs window processing with Sequential Number (SN) assignment in operation 203a. Similarly, the secondary RLC entity 30 performs the window processing with the SN assignment upon receiving the packets from the PDCP entity 10 in operation 203b. When the primary RLC entity 20 obtains the first transmission opportunity, the primary RLC entity 20 transmits the received packet to a Media Access Control (MAC) layer of the network in operation 204a. Similarly, the secondary RLC entity 30 transmits the received packet to the MAC layer of the network when the secondary RLC entity 30 gets the first transmission opportunity in operation 204b.

Upon completing or initiating the transmission of the received packet to the MAC layer, the primary RLC entity 20 sends an acknowledgment to the PDCP entity 10 in operation 205. Similarly, the secondary RLC entity 30 sends an acknowledgment to the PDCP entity 10 in operation 206. As described in FIG. 2, the existing CA architecture for packet transmission results in high radio resource utilization. Each packet transmitted on two independent carriers or paths consumes double the required radio resources. This increased resource utilization can lead to inefficient allocation and management of radio resources. Therefore, an alternative solution is necessary to address this issue.

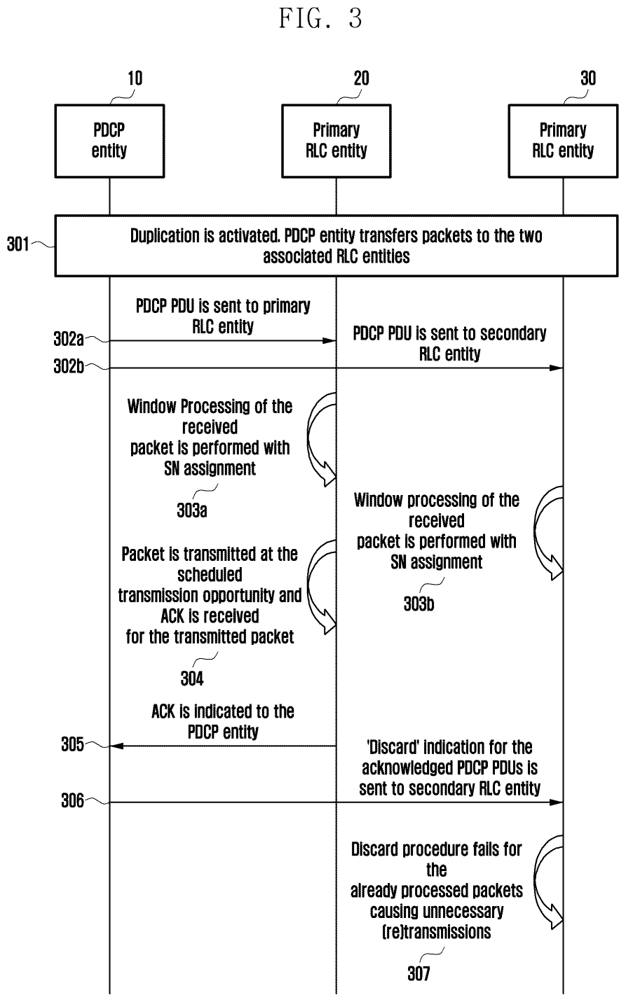

FIG. 3 is a flow diagram illustrating a PDCP-RLC discard mechanism associated with the existing CA architecture, according to the related art.

In operation 301, the PDCP entity 10 transfers packets to the associated RLC entities, namely the primary RLC entity 20 and secondary RLC entity 30, upon detecting the activation of the CA duplication in the network. In operation 302a, when the CA duplication is detected, the PDCP entity 10 transfers the packets (e.g., PDCP PDU) to the primary RLC entity 20. Similarly, in operation 302b, when CA duplication is detected, the PDCP entity 10 transfers the packets to the secondary RLC entity 30. Upon receiving the packets from the PDCP entity 10, the primary RLC entity 20 performs the window processing with the SN assignment in operation 303a. Similarly, the secondary RLC entity 30 performs the window processing with the SN assignment upon receiving the packets from the PDCP entity 10 in operation 303b. When the primary RLC entity 20 obtains the first transmission opportunity, the primary RLC entity 20 transmits the received packet to the MAC layer of the network in operation 304.

Upon completing or initiating the transmission of the received packet to the MAC layer, the primary RLC entity 20 sends an acknowledgment to the PDCP entity 10 in operation 305. Upon receiving the acknowledgment from the primary RLC entity 20, the PDCP entity 10 transmits a discard indication to the secondary RLC entity 30 in operation 306. However, in the PDCP-RLC discard mechanism associated with the existing CA architecture, a discard procedure in operation 307 fails for the already processed packets causing unnecessary (re) transmissions. Therefore, an alternative solution is necessary to address this issue.

In the existing CA architecture, the activation of duplication results in packets being transmitted across all configured activated paths (e.g., path-1, path-2, etc.), which increases radio resource utilization. While this improves reliability and latency, it may not always be necessary, leading to unnecessary packet retransmissions over different legs until explicit notification to discard the packets is received at RLC entities (e.g., 20 and 30) from the PDCP entity 10 and power consumption in processing the packets until identified as duplicate and discarding duplicate packets. Moreover, it reduces the number of User Equipments (UEs) served by the Distributed Unit (DU). The disclosed method addresses these problems associated with the CA architecture by reducing the number of required RLC entities and implementing internal storage or mapping of cell configurations. This allows selective transmission of packets over specific activated duplicated paths as needed, without compromising reliability or latency. Additionally, the disclosed method enables efficient discard and window management at the UE.

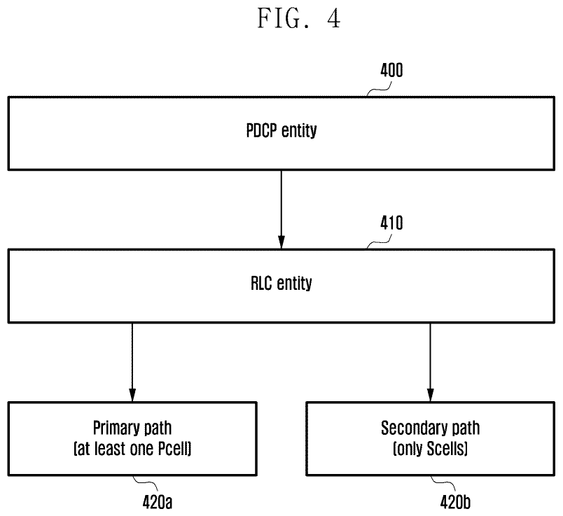

For example, consider a scenario where a mobile network operator uses CA to combine two frequency bands for increased data capacity. When the duplication is activated, packets are transmitted across both paths, consuming more radio resources. However, not all packets may require duplication. With the disclosed method, a system intelligently determines how packets need to be duplicated/shared based on factors such as path configuration and path selection criteria(s). This selective duplication reduces unnecessary resource usage and improves overall efficiency without compromising on reliability or latency, as described in conjunction with FIGS. 4 to 9.

Referring now to the drawings, and more particularly to FIGS. 4 to 9, where similar reference characters denote corresponding features consistently throughout the figures, there are shown preferred embodiments.

FIG. 4 illustrates a disclosed CA duplication architecture, according to an embodiment of the disclosure. The disclosed CA duplication architecture may include a PDCP entity 400, an RLC entity 410 (single RLC entity), associated with a primary path 420a, and a secondary path 420b.

The separation between two carrier paths (i.e., primary path 420a and secondary path 420b) based on serving cell configuration may be maintained internally. As a result, instead of a primary RLC entity and a secondary RLC entity, there may be a notion of primary and secondary paths configured at RLC within the same RLC entity 410. The primary path 420a consists of cells configured for the primary RLC entity. The secondary path 420b consists of cells configured for the secondary RLC entity.

In one or more embodiments, the primary path 420a and the secondary path 420b may be fixed throughout or may be kept only for an initial configuration and later may be changed dynamically depending on a path selection criteria.

In one or more embodiments, when a packet is to be transmitted for a first time, the packet may be transmitted in the primary path 420a, and transmission to the secondary path 420b may be conditional.

In one or more embodiments, one or more state variables at the RLC entity 410 may be modified only for transmission on the primary path 420a. Further, the transmission on the secondary path 420b may not be affected by one or more transmission state (Tx state) variables. Furthermore, one or more receive state (Rx state) variables may be processed regularly whether packets are received from the primary path 420a or secondary path 420b.

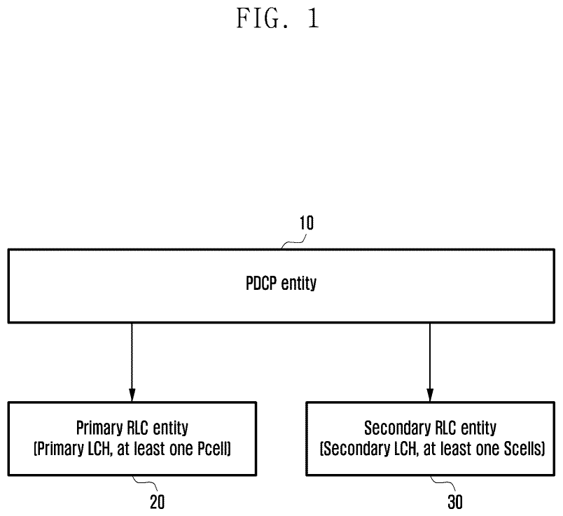

Currently, each data radio bearer (DRB) is mapped to a group of cells. For CA duplication, RLC entities (i.e., primary RLC entity 20 and secondary RLC entity 30) are configured with separate groups of cells, as illustrated in FIG. 1. Here, one of the RLC entity maps to the primary cell group and others to the secondary cell group. For a downlink (DL), this configuration between RLC entity to carrier mapping is left up to a network implementation. According to 3GPP TS 38.331 for an uplink (UL), CellGroupConfig IE->RLC-BearerConfig IE->[LogicalChannelConfig IE, logicalChannelIdentity], is how the cell configuration is defined. The LogicalChannelConfig IE contains allowedServingCells which stores the logical channel to carrier mapping.

With the disclosed CA duplication architecture, the single RLC entity 410 may be mapped to both primary and secondary cell groups. This differentiation may be maintained via the configuration received for the primary and secondary cell groups for the DRB. For the UL, the LogicalChannelConfig IE may be modified to contain allowedServingCells for the primary and secondary cell groups, as described in Table 2 below.

TABLE 2

```
LogicalChannelConfig (Spec 38.331)
LogicalChannelConfig ::= SEQUENCE {
    ul-SpecificParameters SEQUENCE {
  allowedPrimaryServingCells SEQUENCE
  (SIZE (1..maxNrofServingCells-1)) OF
ServCellIndex
  allowedSecondaryServingCells SEQUENCE
  (SIZE (1..maxNrofServingCells-1))
OF ServCellIndex
```

In one or more embodiments, the above differentiation can be done in DL by retaining the per resource block (RB) per logical channel id (LCID) per cell context. This is one method of implementation. Otherwise, it can be maintained using any other method.

In one or more embodiments, for the disclosed CA duplication architecture, the following two aspects may be considered:
a. Path configuration: selecting one path as the primary path 420a and the other as secondary path 420b among multiple paths/carriers.
b. Path selection: for a particular packet, deciding if the particular packet needs to be transmitted on only primary path 420a, and/or secondary path 420b.

The decision of which path(s) to use for transmitting a particular packet is based on various factors as mentioned below and performance with respect to the desired KPI. The decision may be made using one or several of the following information/statistics (depending on implementation-specific criteria/path configuration criteria).
a. Current signal quality indicators like a Channel Quality Indicator (CQI), a Signal-to-Interference-plus-Noise Ratio (SINR), and a Reference Signal Received Power (RSRP);
b. Success transmission rate in a current window (e.g., K transmissions);
c. Statistics collected over all active transmission paths (e.g., primary path 420a, secondary path 420b, etc.) for a fixed number of transmissions; and
d. Support of a specific service/slice type, network slice selection assistance information (NSSAI) in conjunction with quality of service (QOS) class identifier (QCI)/5G QoS identifier (5QI) (depending on deployment may be used to decide path(s) to use for a first transmission).

Additionally, irrespective of the implementation-specific criteria, If the first transmission is not received by the receiver as indicated by a Hybrid Automatic Repeat Request (HARQ) feedback, subsequent retransmissions will be immediately performed on both paths (i.e., primary path 420a and secondary path 420b). The path selection process is repeated for either every transmitted packet, for a duration of a Dynamic Downlink Data Scheduling (DDDS) period, or a specific timer duration depending on the implementation-specific criteria. This frequent regulation of path performance ensures the appropriate path is chosen to meet the required Key Performance Indicators (KPIs) of the communication services.

In one or more embodiments, the path configuration may be done at one of the following events/packet-specific criteria:
a. For each data packet transmission;
b. At regular intervals that are configured (for example, every 100 milliseconds); and
c. DDDS transmission (for example, when a DDDS signal is sent).

In one or more embodiments, in order to collect the required information for Path configuration, a specific number of data packets (predefined number of data packets) will initially be sent through both paths. The following information will be collected over a defined window that covers the last K transmissions (K is specific to the implementation-specific criteria):
1. Signal quality indicators (like CQI, SINR, or RSRP) for each transmission;
2. Mapping between the signal quality indicators and transmission results (success or failure); and
3. The average success rate of the first transmission.

By using the above-mentioned information from (1: “signal quality indicators”) and (2: “mapping”), the disclosed method may determine an average signal quality (Aval) (average limit of signal quality) and a lowest acceptable signal quality (Lval) (lower limit of signal quality) for all successful transmissions within the current window. The following conditions may be applied in the specified order for the path configuration (one or more path configuration conditions):
a. If the current signal quality indicator of a path-1 is greater than the Aval for the path-1 and the same of a path-2 is lesser than the Aval, then the path-1 is configured as the primary path 420a and the path-2 as the secondary path 420b. As shown in Table 3, the following data indicates the above-mentioned condition for the path configuration for the current Tx window, where the path-1 is configured as the primary path 420a, and the path-2 is configured as the secondary path 420b. So, if any packet has to be transmitted, it will be transmitted only on the path-1 for the first transmission.

TABLE 3

| Data | Path-1 | Path-2 |
|---|---|---|
| Aval | 13.5 | 12.5 |
| Lval | 11 | 11 |
| Current signal | 14 | 12 |
| quality indicator | | |

b. If the difference between the current signal quality indicator of the path-1 and path-2 is greater than a defined threshold (a), then the greater current signal quality path is configured as the primary path 420a and the other path as the secondary path 420b.
c. Using (1) and (2), a probability of success is calculated for the case when the current signal quality indicator is less than the Aval. This is calculated for both paths as shown in Equation 1 below,

$$probability of success = \frac{\begin{matrix}Total Num of successful Tx \\ when the current signal quality \\ indicator is less than Aval\end{matrix}}{\begin{matrix}Total Num of Tx when the \\ current signal quality \\ indicator is less than Aval\end{matrix}} \qquad Equation 1$$

If the difference between this value for the 2 paths is greater than a defined threshold, then the path with the greater value is configured as the primary path 420a and the other one as the secondary path 420b.

As shown in Table 4, the following data indicate the above-mentioned condition for the path configuration for the current Tx window, where the path-2 is configured as the primary path 420a and the path-1 as the secondary path 420b. Here, if the packet has stringent requirements (e.g., URLLC), the packet may be sent across both paths (i.e., primary path 420a and secondary path 420b) or else only on the primary path 420a.

TABLE 4

| Data | Path-1 | Path-2 |
|---|---|---|
| Aval | 13.5 | 12.5 |
| Lval | 11 | 11 |
| Current signal quality indicator | 12 | 12 |
| Num. of Successful Tx when Current | 100 | 90 |
| signal quality indicator < Aval | | |
| Num. of Total Tx when Current | 120 | 100 |
| signal quality indicator < Aval | | |

d. If none of the above conditions are met, then the path with a higher value (3) is configured as the primary path 420a and the other as the secondary path 420b. In this case, even for the first transmission, the packet may be sent on both paths.

In one or more embodiments, one reason for giving CQI criteria higher precedence than current window performance is to account for any sudden short disruptions (blockage) in the path between the UE and the Network.

In one or more embodiments, for bearers that have stringent requirements (identifiable using NSSAI/5QI/QCI/other latency and reliability requirements), the path selection for both cases C and D may indicate transmission on both the paths (i.e., primary path 420a and secondary path 420b).

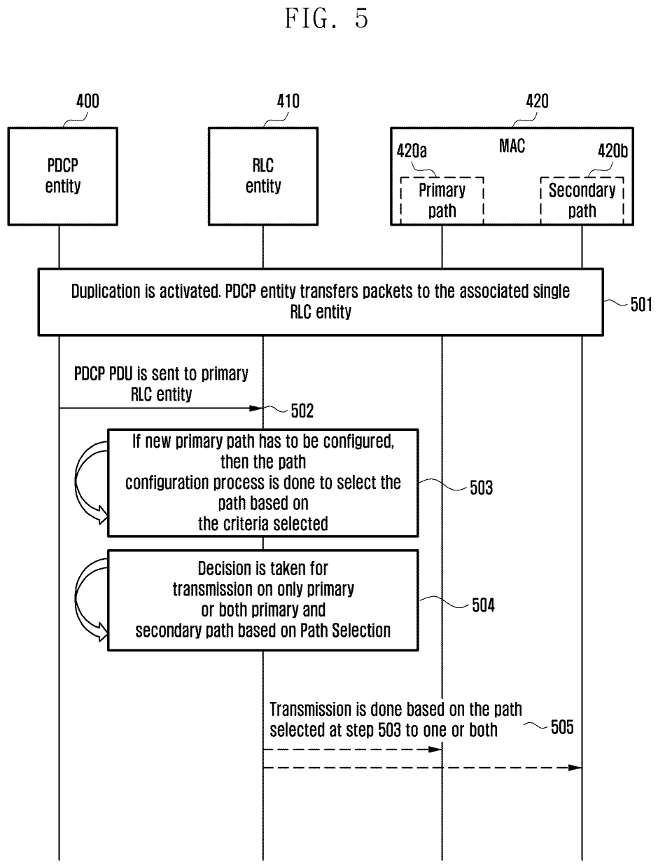

FIG. 5 is a flow diagram illustrating a method for transmitting the packet with the single RLC entity (i.e., RLC entity 410) based on the path configuration and the path selection, according to an embodiment of the disclosure. The method includes one or more network entities such as the PDCP entity 400, the RLC entity 410, and a Media Access Control (MAC) 420. The MAC 420 comprises the primary path 420a and the secondary path 420b.

In operations 501 and 502, the method includes detecting that the duplication is activated. The PDCP entity 400 transfers the packets to the associated RLC entity 410. The method includes sending a Protocol Data Unit (PDU) to the RLC entity 410. In operation 503, the method includes determining whether a new primary path is configured. The method further includes performing the path configuration to select the path based on the criteria selected in response to determining that the new primary path is configured, as described in conjunction with FIG. 4.

In operation 504, the method includes determining an optimal path(s) for packet transmission based on the path selection, as described in conjunction with FIG. 4. The optimal path may include the primary path 420a and/or the secondary path 420b. In operation 505, the method includes sending the packet via the primary path 420a and/or the secondary path 420b based on the determined optimal path(s).

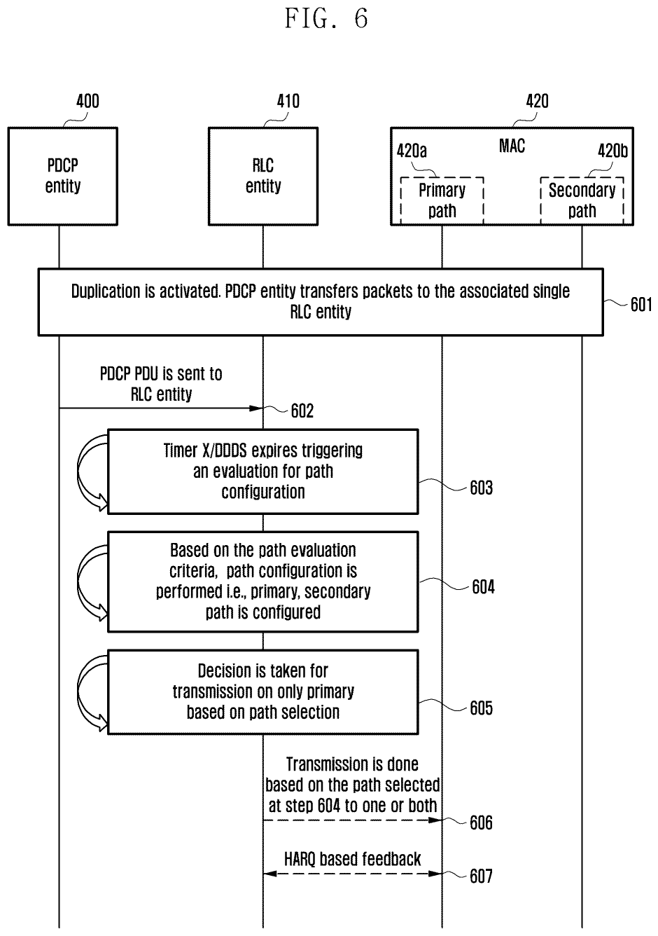

FIG. 6 is a flow diagram illustrating a method for transmitting the packet with the single RLC entity based on the path configuration and the path selection by utilizing a timer (e.g., DDDS or a new timer), according to an embodiment of the disclosure.

In operations 601 and 602, the method includes detecting that the duplication is activated. The PDCP entity 400 transfers the packets to the associated RLC entity 410. The method includes sending a Protocol Data Unit (PDU) to the RLC entity 410. In operation 603, the method includes detecting that the timer is expired. The method further includes triggering an evaluation based on the criteria for the path configuration, as described in conjunction with FIG. 4.

In operation 604, the method includes performing the path configuration based on the evaluation of the path configuration. In operation 605, the method includes determining the optimal path (e.g., the primary path 420a, secondary path or both primary, secondary) for packet transmission based on the path selection, as described in conjunction with FIG. 4. In operation 606, the method includes transmitting the packet on the determined optimal path/based on the evaluation of the path configuration. In operation 607, the method includes receiving the HARQ-based feedback from the determined optimal path (e.g., primary path 420a), as described in conjunction with FIG. 4.

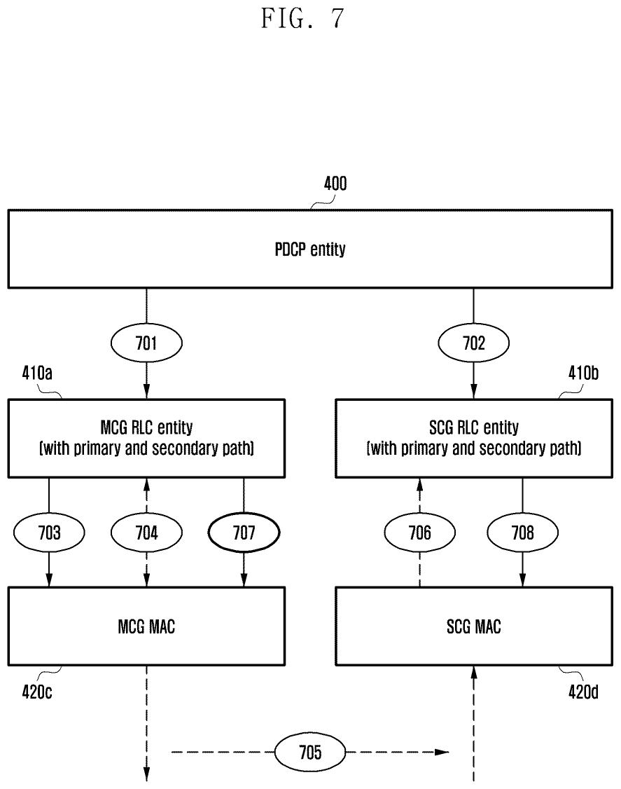

FIG. 7 illustrates a disclosed CA-DC duplication architecture, according to an embodiment of the disclosure.

The disclosed CA-DC duplication architecture comprises a leg-1 and a leg-2. The leg-1 (master cell group (MCG) leg) comprises two RLC entities (MCG RLC entity 410a) and an MCG MAC 420c. The leg-2 (secondary cell group (SCG) leg) comprises two RLC entities (SCG RLC entity 410b) and a SCG MAC 420d. As a result, there are four possible paths for the packet transmission. The disclosed CA-DC duplication architecture upgrades might be deployed individually on both legs (i.e., MCG Leg and SCG Leg) in this case. As a result, two transmissions are performed instead of four transmissions. If the primary pathways' performance is adequate, this may be an easy solution to achieve the requisite reliability. This decision may be made using one of the following options or a combination of them (first method and second method). If the first transmission is not received by the receiver as indicated by the HARQ feedback, successive (re-) transmissions may be performed immediately on both primary and secondary pathways on both MCG and SCG Legs.

In one or more embodiments, the disclosed CA-DC duplication architecture may utilize a first method mentioned below to enhance optimization. Further enhancements may be considered by sending the packet on only one path out of four paths. In the first method, the packet should be sent on both legs, but the first transmission may only happen on one leg, (i.e., the leg-1) 701/703, (and one path on the leg). The packet sent to the leg-2 702 may be indicated using metadata to not send immediately and wait for an indication from the MAC (e.g., MCG MAC 420c, SCG MAC 420d, etc.).
a. If the leg-1 receives a HARQ ACK 704, then it indicates the same to the leg-2 using a low latency MAC to MAC communication 705. The packet is discarded on the leg-2 without transmission 706 and 708.
b. If the leg-1 receives a HARQ negative acknowledgment (NACK) 707, this is also indicated to the leg-2 705. Now the packet may be sent on both the primary and secondary paths of the leg-1 and at least on the primary path (e.g., primary path 420a) of the leg-2. So, for the first transmission, only one transmission is required and for a second transmission, a minimum of three transmissions are required.

In one or more embodiments, a decision to configure which leg would be the leg-1 out of two legs may determine based on a calculation of possible throughput based on configured bandwidth and a subcarrier spacing for latency. A leg with a higher possible throughput and a lower latency may be more preferable to the leg-1.

In one or more embodiments, the leg-1 and leg-2 configurations might be made dynamic as well, depending on criteria similar to those mentioned for the CA duplication.

In one or more embodiments, the disclosed CA-DC duplication architecture may utilize a second method mentioned below to enhance optimization. A time indication (time delay) may be used alternatively in the second method. The time delay may be determined by the MAC (e.g., MCG RLC entity 410a and SCG RLC entity 410b) of the corresponding leg. Based on the time delay, the MAC may take the decision to transmit or not. The time delay may basically be the estimated time delay for the HARQ feedback at the leg-2. If no HARQ feedback is received at the leg-2 till the time delay, the packet may be processed and transmitted. The time delay constitutes a total DL delay, a total UL delay, and a MAC communication delay, as mentioned in Equation 2, Equation 3, and Equation 4 below.

$$Total DL delay = Network ( NW ) DL Tx delay + Air time delay from the NW to UE + UL MAC processing delay at the UE \qquad Equation 2$$

$$Total UL delay = UE UL HARQ feedback processing delay + Air time delay from the UE to NW + UL MAC processing delay at the NW \qquad Equation 3$$

$$MAC communication delay = Delay for feedback \\ communication from the leg - 1 MAC to the leg - 2 MAC \qquad Equation 4$$

The NW DL Tx delay is the time taken for a packet to be transmitted from the PDCP entity 400 to a physical (PHY) layer. The UL MAC processing delay at the UE is the time taken for the UE to process the HARQ-related information for the received transport block (TB) and create the HARQ feedback. The Air time delay is the time taken for the transmitted signal from the NW/UE to reach the UE/NW. This may also be estimated using timing advance. The UE UL HARQ feedback processing delay is a time taken at the NW to process the HARQ feedback sent by the UE. The UL MAC processing delay at the NW is a time taken to process the HARQ Feedback received from the primary path 420a.

Consider an example scenario of Sub Carrier Spacing (SCS) at 30 kilohertz (KHz), where 1 symbol equals 1/28=0.03571428571 milliseconds. The following formulas (i.e., Equation 2, Equation 3, and Equation 4) are utilized to estimate the total DL delay.
a. Approximate total DL delay=NW DL Tx delay (4)+Air time delay from NW to UE(1)+UL MAC processing delay at UE(2)=7 symbols;
b. Approximate total UL delay=UE UL HARQ Feedback Tx Delay (4)+Air time delay from UE to NW (1)+UL MAC processing delay at NW (2)=7 symbols;
c. Approximate MAC communication delay=2 symbols;
d. Approximate total delay=7+7+2=16 symbols.

If the leg-2 doesn't receive the HARQ ACK till 16 symbols, then the leg-2 may process and transmit the packet from its end (either on the primary path 420a or both primary path 420a and secondary path 420b). Considering the approximate total DL delay (7), the UE may have received the packet from the leg-2 as well by 23rd symbol (packet from the leg-1 may already be received a bit earlier). In the 30 KHz SCS, since there are 28 symbols available for 1 ms, at least one retransmission is guaranteed within the time limit (the time limit for even URLLC) in this way.

In general, the CA may be categorized into two types: Intra-band CA and inter-band CA. In the intra-band CA, carriers are from the same frequency band, while in the inter-band CA, carriers come from different frequency bands. From a network deployment perspective, an intra-DU CA includes a single Distributed Unit (DU) where both primary and secondary component carriers belong to the same DU. On the other hand, the inter-DU CA includes one Centralized Unit (CU) connected to multiple DUs, allowing primary and secondary component carriers to belong to different DUs.

In one or more embodiments, for the intra DU CA, the disclosed CA-DC duplication architecture optimally utilizes the single RLC entity (e.g., RLC entity 410, MCG RLC entity 410a, SCG RLC entity 410b, etc.).

In one or more embodiments, for inter DU CA, consider an example with 1 CU connected to 3 DUs: DU1, DU2, and DU3. Connectivity is established only between DU1 and DU3, leaving DU2 disconnected. The disclosed CA-DC duplication architecture involving the single RLC entity is feasible only when the DUs are interconnected. Taking the example given, the single RLC entity setup can be implemented between DU1 and DU3, as there is communication support between the RLC entity in one DU and the Media Access Control (MAC) entity in the other DU. This optimization results in one Packet Data Convergence Protocol (PDCP) RLC interface and two RLC MAC interfaces (with a single RLC entity associated with the MAC on both DUs).

In one or more embodiments, the transmission mechanism for the CA duplication remains the same as described above. All the advantages of the disclosed CA-DC duplication architecture are applicable to all CA types. Further, window processing occurs at the single RLC (e.g., RLC entity 410, MCG RLC entity 410a, SCG RLC entity 410b, etc.) which eliminates the need for flush and discard.

In one or more embodiments, in the existing CA architecture, even after getting acknowledgment on one RLC entity (e.g., primary RLC entity 20), retransmissions on the second RLC entity (e.g., secondary RLC entity 30) can continue in the event of NACK (e.g., HARQ or session protocol data unit (SPDU)). This is unnecessary because the packet from the other leg has already arrived at the UE. There are no such drawbacks with the disclosed CA duplication architecture and CA-DC duplication architecture.

In one or more embodiments, IE modification (i.e., LogicalChannelConfig (Spec 38.331)) may cover all CA instances for the DU and UE. The cell information may be indicated to the UE via the allowedSecondaryServingCells in LogicalChannelConfig IE. ServingCellConfigCommon IE is mapped to the IE, which contains physical cell ID (PCI). This information is sufficient to connect to the appropriate DU.

For a handover (HO) scenario, the handover preparation phase is a first phase in the HO that may determine whether the HO is performed or not. In this step, all the UE context and other relevant information is shared by a source node to a target node. The disclosed CA duplication architecture and CA-DC duplication architecture comprise a single RLC entity mode support, which may be utilized for a communication during the HO as well as an initial setup. Based on it, the network/UE may configure either the single RLC entity (e.g., RLC entity 410, MCG RLC entity 410a, SCG RLC entity 410b, etc.) or follow the default existing multiple RLC entity mode/default existing RLC entity mode accordingly. There are two cases possible with the HO as follows:
a. Case A—All the involved entities (e.g., source node, target node, UE) support the single RLC entity mode. Therefore, the single RLC entity (e.g., RLC entity 410, MCG RLC entity 410a, SCG RLC entity 410b, etc.) is configured.
b. Case B—One of the involved entities (e.g., target node, UE) does not support the single RLC entity mode. If any one of the nodes does not support the single RLC entity mode then it may always use the default existing RLC entity mode. For example, multiple scenarios are described below.
i. The source node may share the UE context comprising the default existing RLC entity mode in the HO preparation request along with an indication of UE's single RLC entity mode support (optionally). So, if both UE and target node support the single RLC entity mode then the same can be configured and sent in a HO response message. Otherwise, the default existing RLC entity mode is configured by the target node for the UE. The corresponding configuration is sent to the UE in a radio resource control (RRC) reconfiguration message.
ii. The source node may share the UE context comprising the single RLC entity mode which implicitly indicates that the UE also supports the single RLC entity mode. If the target node supports the single RLC entity mode, the same is configured for the UE. Based on the received RRC reconfiguration message, the UE may establish an RLC entity correspondingly. If the target node doesn't support the single RLC entity mode, then either it can reject the HO request or send the configuration with the default existing RLC entity mode to the UE. As the UE may support both modes in this case, there is no issue.
iii. The source and target nodes support the single RLC entity mode, but if the UE doesn't support the single RLC entity mode then the UE may always be configured with the default existing RLC entity mode.

In all of the aforementioned cases, the UE may indicate support for the single RLC entity mode either (a) in response to an explicit information request from the network; (b) the UE may simply respond with an accept/reject for the RRC reconfiguration message received (accept/reject with a cause indicating “default RLC entity mode only”); or (c) the UE may indicate this as part of RLC parameters in the UE capability information (as per 3GPP TS 38.306) that is shared by the source node to target node. In one or more embodiments, a new parameter called singleRLC-CADuplication will be added to indicate the single RLC entity mode support as a mandatory parameter.

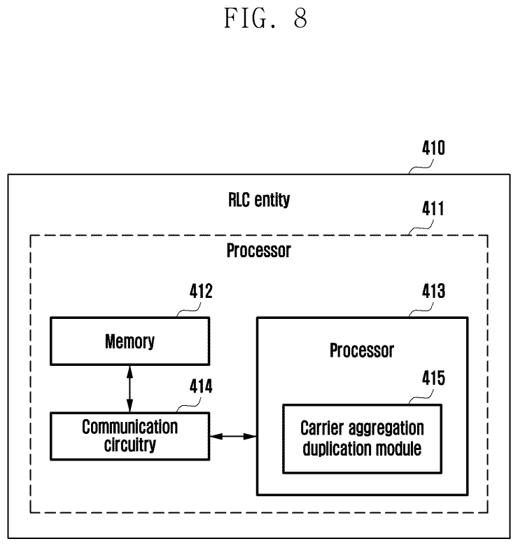

FIG. 8 illustrates a block diagram of the RLC entity 410 for managing CA duplication in a network device (i.e., network entity), according to an embodiment of the disclosure.

In an embodiment, the RLC entity 410 comprises a system 411. The system 411 may include memory 412, a processor 413, and communication circuitry 414.

In an embodiment, the memory 412 stores instructions to be executed by the processor 413 for managing carrier aggregation (CA) duplication in the network entity (e.g., MCG RLC entity 410a, SCG RLC entity 410b, etc.), as discussed throughout the disclosure. The memory 412 may include non-volatile storage elements. Examples of such non-volatile storage elements may include magnetic hard disks, optical discs, floppy disks, flash memories, or forms of electrically programmable read only memory (EPROM) or electrically erasable and programmable ROM (EEPROM) memories. In addition, the memory 412 may, in some examples, be considered a non-transitory storage medium. The term “non-transitory” may indicate that the storage medium is not embodied in a carrier wave or a propagated signal. However, the term “non-transitory” should not be interpreted as that the memory 412 is non-movable. In some examples, the memory 412 can be configured to store larger amounts of information than the memory. In certain examples, a non-transitory storage medium may store data that can, over time, change (e.g., in Random Access Memory (RAM) or cache). The memory 412 can be an internal storage unit, or it can be an external storage unit of the RLC entity 410, a cloud storage, or any other type of external storage.

The processor 413 communicates with the memory 412, and the communication circuitry 414. The processor 413 may include a carrier aggregation duplication module 415. The processor 413 is configured to execute instructions stored in the memory 412 and to perform various processes for managing the CA duplication in the network entity, as discussed throughout the disclosure. The processor 413 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communication circuitry 414 is configured for communicating internally between internal hardware components and with external devices (e.g., server) via one or more networks (e.g., radio technology). The communication circuitry 414 includes an electronic circuit specific to a standard that enables wired or wireless communication.

The carrier aggregation duplication module 415 is implemented by processing circuitry such as logic gates, integrated circuits, microprocessors, micro controllers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the carrier aggregation duplication module 415 may configure a plurality of carrier paths in at least one radio link control (RLC) entity (e.g., RLC entity 410) of the network entity. The carrier aggregation duplication module 415 may configure at least one path as the primary path (primary path 420a) and at least another path as the secondary path (secondary path 420b) from among the plurality of configured carrier paths based on the path configuration criteria, as described in conjunction with FIG. 4. The path configuration criteria comprise one or more parameters, the one or more parameter comprises the signal quality indicator, the transmission success rate, and the signal quality to the transmission result mapping, where the current signal quality indicator comprises the CQI, the SINR, and the RSRP. The carrier aggregation duplication module 415 may select at least one of the primary path 420a and the secondary path 420b for transmission of data packets based on at least one of the path configuration criteria and the packet-specific criteria, as described in conjunction with FIG. 4. The packet-specific criteria comprise at least one of a packet reliability requirement, a packet latency requirement, and a packet type, wherein the packet type comprises a new packet, a retransmission packet, and a high priority packet. The carrier aggregation duplication module 415 may transmit the data packets on the selected paths, as described in conjunction with FIGS. 5 and 6.

In one or more embodiments, the carrier aggregation duplication module 415 may detect an occurrence of an event as a trigger for path configuration, as described in conjunction with FIG. 4. The event comprises either an expiry of pre-configured periodicity, after every N packet transmission and at downlink data delivery status (DDDS) transmission or a combination of any based-on implementation. The carrier aggregation duplication module 415 may configure, upon detecting the occurrence of the event, the at least one path as the primary path 420a and the at least another path as the secondary path 420b from the plurality of configured carrier paths.

In one or more embodiments, the carrier aggregation duplication module 415 may maintain a mapping of serving cell groups to the configured primary path 420a and the secondary path 420b.

In one or more embodiments, the network entity may indicate the mapping of the serving cell groups to the UE by one of:
a. Adding a new field within a logical channel configuration information element (IE) under uplink (UL) specific parameters specifically for the primary serving cells, which may relate to Table 2; or
b. Adding a new field within a logical channel configuration IE under UL-specific parameters specifically for the secondary serving cells, which may relate to Table 2.

In one or more embodiments, the carrier aggregation duplication module 415 may determine whether the network entity and the UE support the single RLC entity mode. The carrier aggregation duplication module 415 may perform one of:
a. Utilizing the single RLC entity (e.g., RLC entity 410, MCG RLC entity 410a, SCG RLC entity 410b, etc.) for an event when the single RLC entity mode is supported by the network entity and the UE; or
b. Utilizing a plurality of RLC entities when any of network entities or the UE does not support the single RLC entity mode.

In one or more embodiments, the UE may indicate that the UE supports the RLC entity 410 to the network entity. The UE may send a single RLC entity mode support indication by at least one of:
a. Upon receiving an explicit information request from the network;
b. Responding to a received RRC reconfiguration message with an accept response or a reject response with a cause indicating that the UE supports a default RLC entity mode only; or
c. Adding a new parameter single RLC-CA Duplication parameter as part of existing RLC parameters in the UE capability information.

In one or more embodiments, the network entity may indicate the mapping of the serving cell groups to the UE with the new field in the LogicalChannelConfig IE under ul-SpecificParameters for primary and secondary serving cells separately.

In one or more embodiments, the carrier aggregation duplication module 415 may initially transmit the predefined number of data packets across configured primary and secondary paths among the plurality of carrier paths, as described in conjunction with FIG. 4. The carrier aggregation duplication module 415 may obtain, upon transmit the predefined number of data packets, information associated with the path configuration criteria is maintained, where the information comprises of current signal quality indicator per transmission, the mapping between the current signal quality indicator per transmission and the result of transmission, and the average first transmission success rate. The carrier aggregation duplication module 415 may determine, based on the current signal quality indicator per transmission, and the mapping between the current signal quality indicator per transmission and the result of transmission, the average limit (Aval) and the lower limit (Lval) of signal quality for all successful transmissions in the current window, as described in conjunction with FIG. 4. The carrier aggregation duplication module 415 may configure at least one path as the primary path 420a and at least another path as the secondary path 420b from the plurality of configured carrier paths based on the obtained information and the one or more path configuration conditions, as described in conjunction with FIG. 4, which are given below.
a. Configuring the path-1 as the primary path 420a among the plurality of carrier paths and the path-2 as the secondary path 420b among the plurality of carrier paths when the value of the current signal quality indicator of path-1 is greater than the Aval of path-1 and the value of the current signal quality indicator of path-2 is lesser than the Aval path-2, and vice-versa;
b. Configuring the path-1 as the primary path 420a and the path-2 as the secondary path 420b when the difference value between the current signal quality indicator of path-1 and the current signal quality indicator of path-2, is greater than the pre-defined implementation-based threshold (a) value, and the value of the current signal quality indicator of the path-1 is greater than the value of the current signal quality indicator of path-2 and vice-versa;
c. Configuring the path-1 as the primary path 420a and the path-2 as the secondary path 420b when the current signal quality indicator of both paths is less than the Aval, is determined based on the probability calculated for the successful transmissions, wherein the probability of a total number of successful transmissions to the total number of transmissions when the current signal quality indicator is less than Aval over each path and the difference of probability values between the paths is greater than a pre-defined threshold wherein the value of path-1 is greater than path-2; and vice-versa; and
d. Configuring the path-1 as the primary path 420a and the path-2 as the secondary path 420b when an average first transmission success rate of the path-1 is greater than the average first transmission success rate of the path-2; and vice-versa; with packet transmission over both the paths to satisfy a packet reliability requirement.

In one or more embodiments, the carrier aggregation duplication module 415 may manage Dual Connectivity (DC) with CA duplication in the network entity, as described in conjunction with FIG. 5. The carrier aggregation duplication module 415 may configure either one of a Master Cell Group (MCG) or Secondary Cell Group (SCG) as the leg-1 and the other as the leg-2 based on at least one of one or more static parameters and one or more dynamic parameters. The carrier aggregation duplication module 415 may configure the plurality of carrier paths in at least one radio link control (RLC) entity (single RLC entity 410) of the network entity. The carrier aggregation duplication module 415 may configure at least one path as the primary path 420a and at least another path as the secondary path 420b from the plurality of carrier paths based at least on a path configuration criteria. The carrier aggregation duplication module 415 may monitor one or more transmission conditions on the leg-1, and the leg-2 over their corresponding paths configured by measuring one or more predetermined network parameters. The carrier aggregation duplication module 415 may generate a decision to cause duplication of data packet in response to the monitored one or more transmission conditions. The carrier aggregation duplication module 415 may generate the duplicate data packet. The carrier aggregation duplication module 415 may transmit the generated duplicate data packet on at least one or both the primary path 420a and the secondary path 420b, as described in conjunction with FIG. 5. The carrier aggregation duplication module 415 may execute multiple steps to transmit the data packets to both leg-1 and leg-2 on the configured paths, which are given below.
a. Transmitting the data packets to both leg-1 and leg-2 along with an indication in metadata to leg-2 to not transmit the data packets until a pre-configured timer expiry or a hybrid automatic repeat request (HARQ) based feedback;
b. Receiving the HARQ based feedback from a receiver on leg-1 and sharing with the leg-2 using a MAC-to-MAC communication, wherein the HARQ based feedback indicates the transmitted data packet is received successfully at the receiver and the leg-2 discarding all the data packets corresponding to the HARQ feedback; or
c. Re-transmitting the data packet on both legs when the HARQ-based feedback indicates that the transmitted data packet is not received successfully at the receiver.

In one or more embodiments, the carrier aggregation duplication module 415 may determine the one or more static parameters based on configured bandwidth and subcarrier spacing to determine the possible throughput and latency. The carrier aggregation duplication module 415 may assign a preference to the leg-1 as the leg with a higher possible throughput and a lower latency based on the determined static parameter. The carrier aggregation duplication module 415 may determine the one or more dynamic parameters based on the path configuration criteria associated with the CA.

Although FIG. 8 shows various hardware components of the RLC entity 410, but it is to be understood that other embodiments are not limited thereon. In other embodiments, the RLC entity 410 may include less or more number of components. Furthermore, the labels or names of the components are used only for illustrative purposes and do not limit the scope of the disclosure. One or more components can be combined to perform the same or substantially similar functions to manage the CA duplication in the network entity.

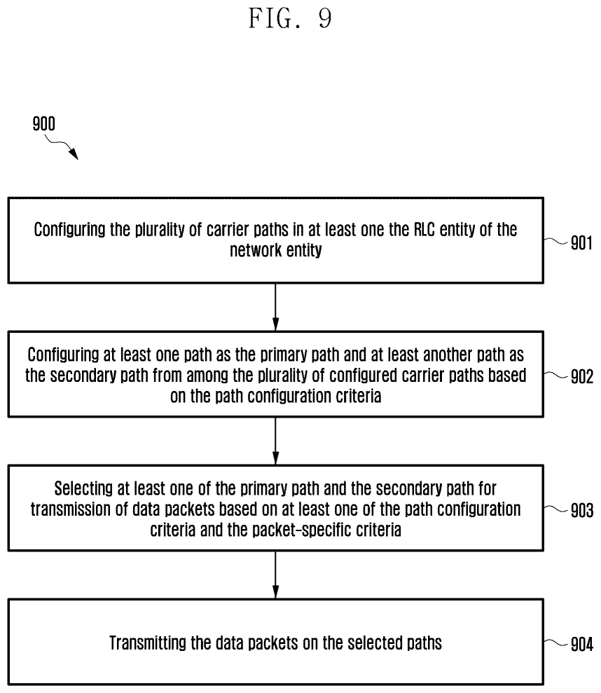

FIG. 9 is a flow diagram illustrating a method 900 for managing the CA duplication in the network device, according to an embodiment of the disclosure.

At operation 901, the method 900 includes configuring the plurality of carrier paths in at least one of the RLC entity (e.g., RLC entity 410, MCG RLC entity 410a, SCG RLC entity 410b, etc.) of the network entity.

At operation 902, the method 900 includes configuring, by the RLC entity 410, at least one path as the primary path 420a and at least another path as the secondary path 420b from among the plurality of configured carrier paths based on the path configuration criteria, as described in conjunction with FIG. 4.

At operation 903, the method 900 includes selecting, by the RLC entity 410, at least one of the primary path 420a and the secondary path 420b for transmission of data packets based on at least one of the path configuration criteria and the packet-specific criteria, as described in conjunction with FIG. 4.

At operation 904, the method 900 includes transmitting, by the RLC entity 410, the data packets on the selected paths, as described in conjunction with FIGS. 5 and 6. Detailed description related to the various operations of FIG. 9 is already covered in the description related to FIGS. 4 to 8 and are omitted herein for the sake of brevity.

In one or more embodiments, the disclosed CA duplication architecture and CA-DC duplication architecture have one or more advantages compared to the existing CA architecture, which are mentioned below.
a. Because only one RLC entity 410 is employed for packet transmission as described in conjunction with FIG. 4, radio resources corresponding to the single RLC entity 410 are consumed while providing the same services as two RLC entities. In the DC+CA duplication scenario as described in conjunction with FIG. 7, radio resources belonging to two RLC entities are conserved.
b. If the performance of the primary path (e.g., primary path 420a) is within acceptable KPI parameters (reliability 10-5, latency 0.5 ms for both DL and UL, jitter 1 us), transmissions on the secondary path (e.g., secondary path 420b) may be drastically reduced.
c. Because there is only one RLC entity (i.e., single RLC entity 410) that contains the packet, flush and discard are no longer required.
d. Increases an overall system's call support capacity and throughput.
e. Power consumption in the network entity is also reduced as the number of packets to be processed decreases.
f. Extraneous retransmissions are decreased when compared to the existing CA architecture.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for managing carrier aggregation (CA) duplication in a network entity, the method comprising:
configuring a plurality of carrier paths in at least one radio link control (RLC) entity of the network entity;
configuring at least one path as a primary path and at least another path as a secondary path from among the plurality of configured carrier paths based on a path configuration criteria;
selecting at least one of the primary path and the secondary path for transmission of data packets based on at least one of the path configuration criteria and a packet-specific criteria; and
transmitting the data packets on the selected paths.

2. The method of claim 1, wherein the configuring of the at least one path as the primary path and the at least another path as the secondary path comprises:
detecting an occurrence of an event as a trigger for path configuration, wherein the event comprises either an expiry of pre-configured periodicity, after every N packet transmission and at downlink data delivery status (DDDS) transmission or a combination of any based on implementation; and
configuring, upon detecting the occurrence of the event, the at least one path as the primary path and the at least another path as the secondary path from the plurality of configured carrier paths.

3. The method of claim 1,
wherein the path configuration criteria comprise one or more parameters,
wherein the one or more parameter comprises a signal quality indicator, a transmission success rate, and a signal quality to a transmission result mapping, and
wherein the signal quality indicator comprises a channel quality indicator (CQI), a signal-to-interference-plus-noise ratio (SINR), and a reference signal received power (RSRP).

4. The method of claim 1,
wherein the packet-specific criteria comprise at least one of a packet reliability requirement, a packet latency requirement, and a packet type, and
wherein the packet type comprises a new packet, a retransmission packet, and a high priority packet.

5. The method of claim 1, further comprising:
maintaining a mapping of serving cell groups to the configured primary path and the secondary path.

6. The method of claim 5, further comprising:
indicating, by a network entity, the mapping of the serving cell groups to a user equipment (UE) by one of:
adding a new field within a logical channel configuration information element (IE) under uplink (UL) specific parameters specifically for primary serving cells, or
adding a new field within a logical channel configuration IE under UL-specific parameters specifically for secondary serving cells.

7. The method of in claim 1, further comprising:
determining whether the network entity and a user equipment (UE) support a single RLC entity mode; and
performing one of:
utilizing a single RLC entity for an event when the single RLC entity mode is supported by the network entity and the UE, or
utilizing a plurality of RLC entities when any of network entities or the UE does not support the single RLC entity mode.

8. The method of claim 1, further comprising:
receiving, from a user equipment (UE), an indication that the UE supports a single RLC entity mode,
wherein the UE sends the indication that the UE supports the single RLC entity mode by at least one of:
upon receiving an explicit information request from the network entity,
responding to a received radio resource control (RRC) reconfiguration message with an accept response or a reject response with a cause indicating that the UE supports a default RLC entity mode only, or
adding a new parameter single RLC-CADuplication parameter as part of existing RLC parameters in UE capability information.

9. The method of claim 5, further comprising:
indicating, by a network entity, the mapping of the serving cell groups to a User Equipment (UE) with a new field in a LogicalChannelConfig IE under ul-SpecificParameters for primary and secondary serving cells separately.

10. The method of claim 1, wherein the configuring of the at least one path as the primary path and the at least another path as the secondary path comprises:
initially transmitting a predefined number of data packets across configured primary and secondary paths among the plurality of carrier paths;
obtaining, upon transmitting the predefined number of data packets, information associated with the path configuration criteria is maintained, wherein the information comprises of current signal quality indicator per transmission, a mapping between the current signal quality indicator per transmission and a result of transmission, and an average first transmission success rate;
determining, based on the current signal quality indicator per transmission, and the mapping between the current signal quality indicator per transmission and the result of transmission, an average limit (Aval) and a lower limit (Lval) of signal quality for all successful transmissions in a current window; and
configuring at least one path as the primary path and at least another path as the secondary path from the plurality of configured carrier paths based on the obtained information and one or more path configuration conditions.

11. The method of claim 10, wherein the one or more path configuration conditions comprise:
configuring a path-1 as the primary path among the plurality of carrier paths and a path-2 as the secondary path among the plurality of carrier paths when a value of the current signal quality indicator of path-1 is greater than an average value (Aval) of path-1 and a value of the current signal quality indicator of path-2 is lesser than an average value (Aval) path-2 and vice-versa;
configuring the path-1 as the primary path and the path-2 as the secondary path when a difference value between the current signal quality indicator of path-1 and the current signal quality indicator of path-2, is greater than a pre-defined implementation-based threshold (a) value, and a value of the current signal quality indicator of the path-1 is greater than the value of the current signal quality indicator of path-2 and vice-versa;
configuring the path-1 as the primary path and the path-2 as the secondary path when the current signal quality indicator of both paths is less than the Aval, is determined based on a probability calculated for the successful transmissions, wherein the probability of a total number of successful transmissions to a total number of transmissions when the current signal quality indicator is less than Aval over each path and a difference of probability values between the paths is greater than a pre-defined threshold, and wherein the value of path-1 is greater than path-2 and vice-versa; and
configuring the path-1 as the primary path and the path-2 as the secondary path when an average first transmission success rate of the path-1 is greater than an average first transmission success rate of the path-2 and vice-versa, with packet transmission over both the paths to satisfy a packet reliability requirement.

12. The method of claim 1, wherein the method is applicable independently for each leg of dual connectivity (DC) when duplication is configured.

13. The method of claim 12, further comprising:
managing dual connectivity (DC) with carrier aggregation (CA) duplication in a network entity,
wherein the managing of the DC with the CA duplication in a network entity comprises:
configuring either one of a master cell group (MCG) or secondary cell group (SCG) as a leg-1 and the other as a leg-2 based on at least one of one or more static parameters and one or more dynamic parameters,
configuring a plurality of carrier paths in at least one radio link control (RLC) entity of the network entity,
configuring at least one path as a primary path and at least another path as a secondary path from the plurality of carrier paths based at least on a path configuration criteria,
monitoring one or more transmission conditions on the leg-1, and the leg-2 over their corresponding paths configured by measuring one or more predetermined network parameters,
generating a decision to cause duplication of data packet in response to the monitored one or more transmission conditions,
generating the duplicate data packet, and
transmitting the generated duplicate data packet on at least one or both the primary and the secondary paths.

14. The method of claim 13, further comprising:
determining the one or more static parameters based on configured bandwidth and subcarrier spacing to determine a possible throughput and latency; and
assigning a preference to the leg-1 as the leg with a higher possible throughput and a lower latency based on the determined one or more static parameter.

15. A network entity for managing carrier aggregation (CA) duplication, the network entity comprising:
memory storing one or more computer programs;
communication circuitry; and
one or more processors operably coupled to the memory and the communication circuitry,
wherein the one or more computer programs include computer-executable instructions that, when executed by the one or more processors, cause the network entity to:
configure a plurality of carrier paths in at least one radio link control (RLC) entity of the network entity,
configure at least one path as a primary path and at least another path as a secondary path from among the plurality of configured carrier paths based on a path configuration criteria,
select at least one of the primary path and the secondary path for transmission of data packets based on at least one of the path configuration criteria and a packet-specific criteria, and
transmit the data packets on the selected paths.

16. The network entity of claim 15, wherein, to configure the at least one path as the primary path and the at least another path as the secondary path, the one or more computer programs further include computer-executable instructions that, when executed by the one or more processors, cause the network entity to:
detect an occurrence of an event as a trigger for path configuration, wherein the event comprises either an expiry of pre-configured periodicity, after every N packet transmission and at downlink data delivery status (DDDS) transmission or a combination of any based on implementation; and
configure, upon detecting the occurrence of the event, the at least one path as the primary path and the at least another path as the secondary path from the plurality of configured carrier paths.

17. The network entity of claim 15,
wherein the path configuration criteria comprise one or more parameters,
wherein the one or more parameter comprises a signal quality indicator, a transmission success rate, and a signal quality to a transmission result mapping, and
wherein the signal quality indicator comprises a channel quality indicator (CQI), a signal-to-interference-plus-noise ratio (SINR), and a reference signal received power (RSRP).

18. The network entity of claim 15,
wherein the packet-specific criteria comprise at least one of a packet reliability requirement, a packet latency requirement, and a packet type, and
wherein the packet type comprises a new packet, a retransmission packet, and a high priority packet.

19. The network entity of claim 15, wherein the one or more computer programs further include computer-executable instructions that, when executed by the one or more processors, cause the network entity to:
maintain a mapping of serving cell groups to the configured primary path and the secondary path.

20. One or more non-transitory computer-readable storage media storing one or more computer programs including computer-executable instructions that, when executed by one or more processors of a network entity, cause the network entity to perform operations, the operations comprising:
configuring a plurality of carrier paths in at least one radio link control (RLC) entity of the network entity;
configuring at least one path as a primary path and at least another path as a secondary path from among the plurality of configured carrier paths based on a path configuration criteria;
selecting at least one of the primary path and the secondary path for transmission of data packets based on at least one of the path configuration criteria and a packet-specific criteria; and
transmitting the data packets on the selected paths.
